(19) United States
(12) Patent Application Publication
(10) Pub. No.: US 2009/0155053 A1
(43) Pub. Date: Jun. 18, 2009

(54) Turbine cooling flow modulation

(75) Inventor: Trevor Speak, Dursley (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/289,687

(22) Filed: Oct. 31, 2008

(30) Foreign Application Priority Data
Dec. 14, 2007 (GB) 0724372.8

(51) Int. Cl. F02C 7/12

(52) U.S. Cl. 415/116; 415/177

(57) ABSTRACT

Cooling air flow in a gas turbine engine, for example to a first turbine rotary stage is modulated in accordance with a predetermined cooling schedule by means of a fluidic valve arrangement disposed in the interior of the engine. Since fluidic valves have no moving parts they are more reliable than conventional mechanical and electrically operated valves and able to withstand better the environment in the interior of a gas turbine engine. The fluidic valves are operated remotely by a relatively small control flow that may be governed by an electrically operated valve mounted externally and under the control of a predetermined cooling schedule.

The invention relates to an arrangement for modulating cooling flow to cooled parts of a gas turbine engine, especially an air cooled turbine stage of a gas turbine engine.

An important consideration in gas turbine engine design is to ensure that certain parts of the engine do not absorb heat to the extent that it is detrimental to their safe operation. The thermal efficiency of the turbine is dependent upon high turbine entry temperature which is, therefore, limited by the turbine blade, turbine disc and nozzle guide vane materials. Continuous cooling of these components allows their operating temperature to exceed the material's melting point without affecting the integrity of the turbine blades. Heat conduction from the blades to the turbine disc requires the disc is also cooled to avoid thermal fatigue and uncontrolled expansion and contraction.

Overall fuel burn of a gas turbine engine could be reduced if the proportion of air used for turbine blade cooling could be varied depending on the requirements of the turbine blades at different engine conditions. At present cooling airflow is metered through fixed orifices and hence the percentage of flow remains substantially constant at all power settings. This cooling system is designed for operation at the maximum required level of cooling, therefore it is wasteful of cooling air at lower power settings when the combustor and turbine operate at lower temperatures. Although engine spool speeds and the compressor output pressure are reduced the fixed dimensions of the cooling air system result in an over-supply of cooling air at cruise speeds. This represents a significant loss of engine efficiency.

Previous attempts to introduce cooling airflow modulation have employed mechanically and/or electrically operated valves inside the engine. However, these attempts have suffered from the drawback of the unreliability of such valves when buried deep inside the engine. The present invention is intended to provide a solution to these problems by dispensing with mechanical or electrical valves inside the engine carcase.

According to one aspect of the present invention there is provided a gas turbine engine cooling flow modulation arrangement comprising a source of cooling flow, a flow path for conducting the cooling flow to a part or parts of the engine to be cooled, at least one fluidic valve means in said flow path for modulating the rate of cooling flow, control means for controlling the valve means whereby the rate of cooling flow is variable.

Preferably the valve means for modulating the rate of cooling flow comprises a plurality of fluidic valves, which may be disposed adjacent the part of the engine to which cooling flow is to be modulated, for example a first turbine nozzle guide vane stage.

In one embodiment of the invention the plurality of fluidic valves receive their main flows from a common source, and also receive their control flows from a common source which may be a valve mounted externally.

The invention and how it may be carried into practice will now be described in more detail with reference to the accompanying drawings in which:

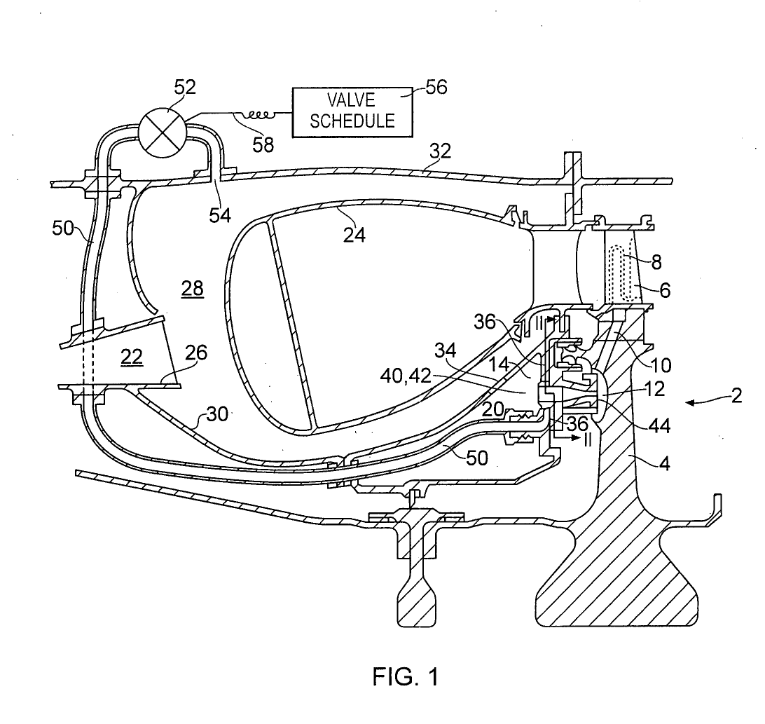

FIG. 1 shows a cross-section view on a radial plane through a combustor and first turbine stage of a gas turbine engine;

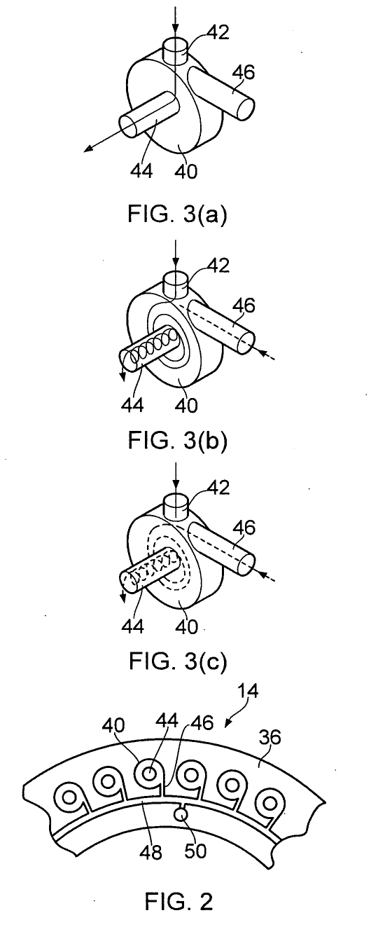

FIG. 2 illustrates a detail view on section A-A of FIG. 1 showing a portion of an annulus of fluidic valves controlling cooling flow into the turbine stage of the engine of FIG. 1; and

FIGS. 3(a), 3(b) and 3(c) are diagrammatic views illustrating three functional modes of operation of a fluidic valve of the kind known as a vortex amplifier.

FIG. 1 depicts a general arrangement of a combustor and high-pressure turbine stage of a typical gas turbine engine in which the turbine rotor is air-cooled. A rotary turbine stage indicated generally at 2 comprises a turbine rotor disc 4 carrying a multiplicity of turbine blades 6 spaced apart around the circumference of the disc 4. The turbine blades are cooled by an internal air system provided with a supply of cooling air derived from the high-pressure compressor portion of the engine. Each of the blades 6 is formed with internal cooling passages indicated generally at 8 by dashed lines. A cooling air supply passage 10 leads from each blade location through the radially outer margin of disc 4 to a common annular recess 12 in one side face of the disc which acts as a cooling air distribution plenum.

In prior art arrangements the recess or plenum 12 receives cooling air from a stationery arrangement of pre-swirl nozzles, which are angled in the direction of rotation of the disc 4. According to the present invention the place of this stationary array of pre-swirl nozzles is taken by an array of fluidic flow modulation valves indicated generally at 14.

The nozzles 14 receive a flow of cooling air from a plenum 20 supplied indirectly from a high pressure outlet 22 of the engine high pressure compressor (not shown). In the illustrated example the engine includes an annular combustor 24 enclosed in an air casing volume 28 formed by inner and outer combustion chamber casings 30, 32. A diffuser 26 at the upstream end of the combustion chamber casings 30, 32 admits air from the high pressure compressor outlet 22 into the casing volume 28. In addition to supplying air into the combustor 24 to support the combustion process the inner casing wall 30 is perforated by a plurality of air transfer ports 34 leading into the plenum 20. Thus, air in the plenum 20 is diverted from the combustion process and used to cool the first stage turbine blades 6.

A downstream side of the plenum 20 is constituted by an annular flange member 36 containing the nozzle arrangement 14. In FIG. 1 the member 36 is depicted in section and in FIG. 2 a segment of the annular member is shown in plan view on line II-II in FIG. 1 in order to reveal the interior structure of the member.

In accordance with a main objective of the present invention it is intended that the supply of cooling air to the turbine blades shall be modulated according to transient cooling requirements of the turbine. This is accomplished in the illustrative example by the nozzle arrangement generally indicated at 14 in FIG. 1, and in more detail in FIG. 2. The nozzle arrangement 14 comprises a plurality of individual fluidic valve arrangements spaced apart around the annular member 36. Each individual nozzle comprises a circular or cylindrical vortex chamber 40, an inlet port 42, an axial outlet port 44 and a tangential control port 46. The circular chambers 40 and outlet ports 44 are spaced apart around the annular member 36 to ensure even distribution of cooling air into the plenum recess 12. The tangential ports 46 are all connected to a common control gallery 48 that, in turn, is coupled to at least one, and preferably several, control pipes 50 spaced apart around the member 36.

Referring now to FIGS. 3(a), 3(b) and 3(c) there is illustrated a fluidic valve of the kind utilised by the invention. It contains no moving parts and its operation is achieved through the interaction of fluid flows. Fluid from an inlet port 42 enters the chamber 40 and makes its way into the outlet port 44. In the absence of any flow through tangential control port 46 into chamber 40, the main flow goes directly from inlet port 42 to the outlet port 46. However, under the influence of increasingly greater tangential control flows at port 46 the main flow takes a progressively greater spiral path between inlet port 42 and outlet port 44 creating a vortex that progressively impedes the main flow. Thus cooling flow to the turbine stage is under the control of a pilot fluid flow carried by control pipe 50.

The term vortex amplifier is derived from the vortex present in the central chamber of the device, and amplifier because viewed one way the flow at the output port is a function of the flow at the control port. In another view the device may be regarded as a switch or valve because the chief part of the flow through the device, i.e. between inlet and outlet ports, may be substantially stemmed by application of a relatively small flow at the control port.

The flow of fluid in each of the control pipes 50 is governed by an external, electrically actuated valve 52, which in the example is mounted on the exterior of the combustor or compressor casing. To reduce the amount of cooling flow to the turbine stage the control valves must deliver more control flow through pipes 50 to the fluidic valves 14. Since the amount of control flow required is substantially less than the amount of cooling flow required at maximum cooling flow this represents a significant saving on air bled from the high pressure compressor output.

In FIG. 1 the control fluid is provided by a connection 54 on the inlet side of control valve 52 which is open to receive fluid from the casing volume 28. Operation of the valve 52 is controlled by an electrical output signal on connection 58 generated by a modulation valve control 56 according to a predetermined control schedule. Such a schedule ultimately delivers more turbine cooling air during periods when more cooling air is required, by reducing the amount of control air delivered to the fluidic valves 14 through control pipes 50. A practical cooling schedule should increase cooling flow during period of increased gas temperature in the turbine, also it should maintain cooling flow for a period after throttle demand for increased power gas been reduced in order to remove residual heat in the components of the turbine section. The system is fail safe, in the event that control flow is disrupted, for example due to a fracture if a pipe 50 or failure of the valve schedule output then control flow to the fluidic valves will be reduced or lost, as a result of which the valves 14 will automatically default to providing maximum cooling flow to the turbine.

Although the invention has been described with particular reference to a turbine rotary stage it will be appreciated that the invention will find wider application. Neither is the invention limited to use with aircraft propulsion engines.

1. A gas turbine engine cooling flow modulation arrangement comprising a source of cooling flow, a flow path for conducting the cooling flow to a part or parts of the engine to be cooled, at least one fluidic valve means in said flow path for modulating the rate of cooling flow, control means for controlling the valve means so as to be capable of modulating the cooling flow.

2. A cooling flow modulation arrangement as claimed in claim 1 wherein the at least one fluidic valve means for modulating the rate of cooling flow comprises a fluidic device of the kind known as a fluidic amplifier.

3. A cooling flow modulation arrangement as claimed in claim 1 wherein the valve means comprises a plurality of fluidic valves arranged to receive a main cooling flow from a common source.

4. A cooling flow modulation arrangement as claimed in claim 2 wherein the control means for each valve means comprises a control flow from a common source

5. A cooling flow modulation arrangement as claimed in claim 1 wherein the common source of control flow comprises a modulation control valve external to the engine.

6. A cooling flow modulation arrangement as claimed in claim 5 wherein the external control valve is electrically energised in accordance with an engine cooling requirement.

7. A cooling flow modulation arrangement as claimed in claim 5 wherein the engine cooling requirement is represented by a predetermined cooling schedule responsive to engine speed and/or fuel flow demand.

8. A cooling flow modulation arrangement as claimed in claim 1 wherein the fluidic valve arrangement is disposed in the interior of the engine.

9. A cooling flow modulation arrangement as claimed in claim 1 wherein the fluidic valve arrangement is disposed adjacent a turbine section of the engine.

10. A cooling flow modulation arrangement as claimed in claim 9 wherein the fluidic valve arrangement is disposed to modulate cooling flow to the first turbine rotary stage.
